(19) United States
(12) Patent Application Publication
(10) Pub. No.: US 2021/0138677 A1
(43) Pub. Date: May 13, 2021

(54) MACHINE AND SYSTEM FOR PREPARING WINDOW SECURITY FILMS FOR INSTALLATION

(71) Applicant: Michael Mayall, Las Vegas, NV (US)

(72) Inventor: Michael Mayall, Las Vegas, NV (US)

(21) Appl. No.: 16/906,383

(22) Filed: Jun. 19, 2020

Related U.S. Application Data
(63) Continuation of application No. 15/338,946, filed on Oct. 31, 2016, now abandoned.

(51) Int. Cl. B26D 5/00; G06Q 50/04

(52) U.S. Cl. CPC B26D 5/005; B65C 9/46; Y02P 90/30; G06Q 50/04

(57) ABSTRACT

A machine for cutting security film includes a platform configured to accept a portion of a roll of security film and at least one securing member for securing the portion of security film to the platform. The machine also includes an arm configured to move across the platform in a first direction and an opposing second direction and a cutting tool movable with the arm. The cutting tool is configured to be placed in a cutting position in which the tool is enabled to cut the security film and a non-cutting position in which the tool is prevented from cutting the security film. The machine also includes a controller configured to receive data associated with dimensions of a window and move the cutting tool in a predetermined pattern to cut at least one window cutout from the portion of the roll of security film corresponding to the dimensions.

### CROSS-REFERENCE TO RELATED APPLICATIONS

This application is a continuation of U.S. application Ser. No. 15/338,946, filed Oct. 31, 2016, the disclosure of which is hereby incorporated by reference in its entirety.

### BACKGROUND

The present application relates generally to security films or laminates for windows and, more particularly, to a machine and system for preparing window security films for installation.

Residences and businesses are often subject to vandalism or theft. One common target for vandalism or theft-related entrance into a residence or business is through the windows of the residence or business. For example, vandals or thieves may break a window on a ground floor of the residence or business to gain entry into the interior of the residence or business.

To combat the ability for thieves or vandals to break windows, window security films or laminates (generally referred to as “security films”) can be installed on the interior surface of the windows. Security films are often formed of a thick, durable, and generally unpliable material that is transparent to enable visibility through the film and window while also improving the window's ability to resist breakage.

Prior to installation of the security film on the windows of a building, security films are typically shipped to an installer in a bulk roll. When the installer prepares to install the security film, the installer typically measures the windows and manually cuts the security film to a shape and size to fit the window.

As a direct result of the security film's durability, however, the films can be difficult to install. For example, the security films are typically thick compared to other window films (e.g., 4 mils or thicker) and are formed of a laminate with an adhesive backing to facilitate adhering to the surface of the window. The security films are also less pliable than other types of window films. The thickness and durability of the laminate may make it difficult to cut. In addition, the thickness, durability, and lack of pliability of the film may make it difficult for an installer to a sheet of film on the window and accurately cut the film to the proper shape and dimensions necessary to fit the window on which the film is to be installed.

In addition, due to the manual nature of the cutting process, significant wastage of the security film may result from the cutting of the film for each window from the roll. For example, the installer may cut out each window's piece of film individually which may result in portions of the roll of film being wasted.

The present disclosure is aimed at solving one or more of the problems identified above.

### BRIEF SUMMARY

In one embodiment, a machine for cutting security film includes a platform configured to accept a portion of a roll of security film and at least one securing member for securing the portion of the roll of security film to the platform so that the portion of the roll is prevented from moving. The machine also includes an arm configured to move across the platform in a first direction and an opposing second direction and a cutting tool movable with the arm and positioned within a cutting area. The cutting tool is configured to be placed in a cutting position in which the cutting tool is enabled to cut the security film and a non-cutting position in which the cutting tool is prevented from cutting the security film. The machine also includes a controller configured to receive data associated with dimensions of a window and move the cutting tool in a predetermined pattern to enable the cutting tool to cut at least one window cutout from the portion of the roll of security film corresponding to the dimensions.

In another embodiment, a film preparation system includes a machine and a labeler. The machine includes a platform configured to accept a portion of a roll of security film and at least one securing member for securing the portion of the roll of security film to the platform so that the portion of the roll is prevented from moving. The machine also includes an arm configured to move across the platform in a first direction and an opposing second direction and a cutting tool movable with the arm and positioned within a cutting area. The cutting tool is configured to be placed in a cutting position in which the cutting tool is enabled to cut the security film and a non-cutting position in which the cutting tool is prevented from cutting the security film. The machine also includes a controller configured to receive data associated with dimensions of a window and move the cutting tool in a predetermined pattern to enable the cutting tool to cut at least one window cutout from the portion of the roll of security film corresponding to the dimensions. The labeler is positioned to receive the window cutout as the window cutout is transported from the cutting area and is configured to attach a label to the window cutout.

In yet another embodiment, a system includes an order processing computer for providing at least one window template, and a film preparation system that includes a machine for cutting security film and a labeler. The machine includes a platform configured to accept a portion of a roll of security film and at least one securing member for securing the portion of the roll of security film to the platform so that the portion of the roll is prevented from moving. The machine also includes an arm configured to move across the platform in a first direction and an opposing second direction and a cutting tool movable with the arm and positioned within a cutting area. The cutting tool is configured to be placed in a cutting position in which the cutting tool is enabled to cut the security film and a non-cutting position in which the cutting tool is prevented from cutting the security film. The machine also includes a controller configured to receive the at least one template and move the cutting tool in a predetermined pattern to enable the cutting tool to cut at least one window cutout from the portion of the roll of security film corresponding to the at least one template. The labeler is positioned to receive the window cutout as the window cutout is transported from the cutting area and is configured to attach a label to the window cutout.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 is a block diagram of an exemplary system that may be used to order and prepare security film for installation.

FIG. 2 is a block diagram of an exemplary user interface that may be used with the system shown in FIG. 1.

FIG. 3 is a side view of an exemplary film preparation system that may be used with the system shown in FIG. 1.

FIG. 4 is a top view of the film preparation system shown in FIG. 3.

### DETAILED DESCRIPTION

As described herein, a system and machine are provided for automatically ordering and preparing window security film or laminate (generally referred to as “security film”) for installation by an installer. The security film may be installed on a plurality of windows within a building, such as within a residence or a business. Alternatively, the security film may be installed in any suitable location as desired.

In an exemplary embodiment, the system includes a web server that provides a web page that is accessible by a user operating a client device, such as a computer, a tablet computing device, or a smartphone, for example. The user may enter the dimensions, locations, and user-defined labels for an order including a plurality of windows to receive security film. Once the user has completed the order, the web server transmits the order data to an order processing computer.

The order processing computer may validate the order by comparing the dimensions of each entered window to one or more stored values representing acceptable dimensions of the windows. The order processing computer creates a window template for each window within the order. In one embodiment, the order fulfillment creates a layout for the window templates corresponding to how the templates are to be arranged and cut out of a roll of security film by a film preparation system. Once the templates and/or the layout is complete, the order processing computer transmits data representative of the templates and/or layout to the film preparation system to complete the order.

The film preparation system includes a cutting machine and a controller that controls the machine. Optionally, the film preparation system also includes a labeler.

The machine includes a cutting tool that is mounted on a movable head. The movable head, in turn, is mounted on a transverse arm that is movable along a platform of the machine using one or more guide arms and a guide motor. The controller controls the movement of the movable head, the transverse arm, and the cutting tool to enable the cutting tool to cut a window cutout corresponding to each window template from the roll of security film.

The labeler, if provided, is configured to print and attach a label to each window cutout to enable the installer to quickly and accurately identify each window cutout to be used during the installation. In one embodiment, each label corresponds to the user-defined label entered in the user interface presented by the web server.

Accordingly, the system described herein enables a user to quickly, efficiently, and conveniently order one or more window cutouts of security film to be used during an installation of security film at a building. The machine enables each window cutout to be accurately cut and significantly improves the speed and efficiency of the window film preparation process as compared to the labor-intensive window film preparation processes currently used.

In addition, the order processing computer may reduce errors in the preparation of the window film by performing automatic validation of the order details, including validating the dimensions of each window entered by the user. The order processing computer may also significantly reduce an amount of security film wasted from the roll of security film when the window cutouts are cut from the roll. For example, the order processing computer may automatically nest or otherwise arrange the window templates in an optimized layout that reduces an amount of the roll needed to create the window cutouts. As a result, the user or the operator of the film preparation system may save money by utilizing the roll of security film more efficiently.

FIG. 1 is a block diagram of an exemplary system 100 (also referred to as an ordering system) for ordering and preparing security film for installation on one or more windows, sliding glass doors, or the like. While the embodiments described herein relate to the preparation of security film, it should be recognized that the embodiments may be used with solar window films, car window films, and any other suitable films with appropriate modifications.

In the exemplary embodiment, system 100 includes a web server 102, an order processing computer 104, and a film preparation system 106. In one embodiment, a client device 108 is enabled to connect to web server 102 as described more fully herein. Example client devices 108 may include, for example, a desktop computer, a laptop computer, a tablet computing device, a smartphone, or any other suitable device that enables client device 108 to operate as described herein. While web server 102, order processing computer 104, and film preparation system 106 are illustrated and described herein as being separate devices or systems, it should be recognized that some or all of web server 102, order processing computer 104, and/or film preparation system 106 may be combined together into one computer, server, or system. For example, the functionality of web server 102 and order processing computer 104 may be combined together within the same server or computer if desired.

Web server 102 hosts and presents one or more webpages on one or more websites accessible to client devices 108. More specifically, client devices 108 use a web browser to access website and webpage hosted by web server 102 through the Internet or another suitable network. Web server 102 includes at least one processor and at least one memory device, such as at least one database stored within a datastore or other permanent storage device. As described more fully herein, web server 102 enables a user operating a client device 108 to input a customized order for one or more window security films through the webpage hosted by web server 102. For example, the user may enter the dimensions of each window onto which the user wants to install security film. Web server 102 receives the order and transmits the order to order processing computer 104.

In one embodiment, the order is stored in the memory device as a plurality of records according to a predefined template. For example, the order may be stored as a plurality of records in an XML template. Accordingly, in such an embodiment, web server 102 transmits the order to order processing computer 104 in the XML format to be processed.

In an alternative embodiment, client device 108 may transmit the order to order processing computer 104 via an alternative mechanism, such as through email, through an FTP server, by connecting directly to order processing computer 104, or by any other mechanism to transmit the order (i.e., the records) to order processing computer 104.

Order processing computer 104 includes at least one processor and at least one memory device. In one embodiment, order processing computer 104 is located within a facility used by film preparation system 106 to cut one or more rolls of security film according to the order details for installation onto one or more windows of an installation site, such as a residence or business.

Order processing computer 104 receives the order (e.g., the records) from web server 102 (or otherwise from client device 108) and processes the order in preparation for film preparation system 106 to implement or fulfill the order. In one embodiment, order processing computer 104 performs error-checking and validation of the order. For example, order processing computer 104 may compare the records corresponding to the order to predefined rules or conditions to ensure that the order is able to be properly fulfilled by film preparation system 106. In a specific embodiment, order processing computer 104 compares the dimensions of each window within the order to a predefined range of dimensions to ensure that the dimensions have been entered correctly in the order. For example, order processing computer 104 may compare the smallest dimension of each window (i.e., the height or width) to a maximum width of the roll of security film used by film preparation system 106 to ensure that a template for each window will fit within the roll. If order processing computer 104 determines that one or more dimensions of the window is incorrect or unable to be processed by film preparation system 106, order processing computer 104 may transmit an error message to web server 102 which in turn transmits an error to the client device 108 through the order web page that the client is using to enter the order. The client may then correct the error and re-enter the window dimensions.

In one embodiment, order processing computer 104 may also process the order to prepare the order for transmittal to film preparation system 106. For example, order processing computer 104 may automatically parse the data contained in the order and optimize the layout of individual window templates corresponding to the dimensions of the windows in the order to fit within a roll of film with minimal wastage as described more fully herein. Order processing computer 104 may also translate the order details, such as the dimensions of the windows or window templates from each record, into a coordinate system used by film preparation system 106. Once the order has been validated and/or processed, order processing computer 104 transmits the order data to film preparation system 106.

Film preparation system 106 prepares the order according to the data received from order processing computer 104. As described more fully herein, film preparation system 106 includes a cutting machine and a controller for controlling the cutting machine. The controller of film preparation system 106 receives the order details, including the templates and/or layout, from order processing computer 104. Film preparation system 106 cuts out the window templates from one or more rolls of film to form window cutouts, and optionally labels the window cutouts according to the order details contained in the records, for example. Once this is done, the order is complete and the window cutouts may be automatically or manually placed into one or more shipping tubes or other containers for transportation to the installation site. As described more fully herein, a legend may be included with the window cutouts to identify which window cutouts were included within the order and that were placed into the shipping tubes or containers.

FIG. 2 illustrates an exemplary user interface 200 that may be presented on a web page provided by web server 102 (shown in FIG. 1). For example, user interface 200 may be presented to a user when the user operates client device 108 to view the web page through the web browser of client device 108.

In one embodiment, user interface 200 includes a list 202 of windows or other components of the order. The list 202 may be arranged as a plurality of rows 204 with each row 204 providing user-fillable or selectable fields 206 associated with a respective window. For example, each row 204 may include a unique identifier 208 for the window within the order, a user entered label 210 for the window, a location 212 of the window within the building, and dimensions of the window including a height 214 of the window and a width 216 of the window. Each row 204 may be stored as an individual record within a file for the overall order. Alternatively, each row 204 may be stored in any suitable manner.

Alternatively, rows 204 can include any suitable fields 206 or data as desired. For example, rows 204 may include one or more fields 206 that enable the user to enter the angle of each corner of the window to account for situations in which the window is not a uniform rectangle. In another embodiment, one or more fields 206 may be replaced by a selectable list of options for that field or a drop-down list that enables the user to select from two or more predefined options for that window.

Unique identifier 208 is unique within the order. For example, unique identifier 208 may include a sequentially increasing number for each row 204 within the order. Alternatively, unique identifier 208 may be any suitable identifier as desired.

Label 210 is a field that enables the user to enter a user-defined description, notation, or name (sometimes referred to as a label) for the window. For example, the user may label a left-most window of a three-part window within the family room of a residence as “Family Room Window 1 (left)”. It should be recognized that any suitable label or description of the window may be entered into the label 210 field as desired.

Location 212 is a field that enables the user to enter a location for the window. For example, the user may label each window within the family room of a residence as “Family Room”. Of course, any suitable location may be entered in the location 212 field.

In the embodiment shown in FIG. 2, an add new row button 218, a delete row button 220, and a submit button 222 may be presented in user interface 200. Add new row button 218 enables the user to add a new row to the list 202 of windows and delete row button 220 enables the user to delete a selected row. As such, the user is able to flexibly add rows to the list or delete rows from the list as the user moves through the building while measuring windows and inputting the order. The submit button 222 enables the user to submit the complete list 202 of windows to order processing computer 104 when the user has finished entering the details of each window within each row.

Once the user selects the submit button 222, the records or other data of the order are saved as an order file. The order file is then transmitted to order processing computer 104 to process the order. For example, the order processing computer 104 may perform validation of the order details and/or may optimize the layout of individual window templates corresponding to the dimensions of the windows in the order to fit within a roll of film with minimal wastage.

In one embodiment, web server 102 may perform validation on the entered details of the order in addition to or alternative to the order processing computer 104 performing the validation. For example, as the user enters the height and the width of each window, web server 102 may compare each entered dimension to a stored value representative of a maximum height or width allowable for the window. In a specific embodiment, the maximum height or width may be equal to the width of the roll of security film used by film preparation system 106 with an optional margin of error to account for any buffer zone the film preparation system 106 may add to each side of the window cutout during the film cutting phase. If the user-entered height or width exceeds a maximum allowable height or width, web server 102 may cause user interface 200 to present an error message to the user informing the user of the exceeded maximum height or width and requiring the user to re-enter an allowable height or width. It should be recognized that the foregoing example is only for illustrative purposes, and any suitable error checking and/or errors may be provided by web server 102.

When order processing computer 104 receives the order data (i.e., the order file or any other suitable form in which the data is transmitted), order processing computer 104 may validate the data in a similar manner as described above with reference to web server 102. Accordingly, order processing computer 104 may compare the entered height and width to stored values representing the maximum height or width allowable, and may generate an error signal or message that may be presented to the user on user interface 200 if the user-entered height or width exceeds the maximum value. Alternatively or additionally, order processing computer 104 may perform any suitable validation of the order data as desired.

In an exemplary embodiment, order processing computer 104 creates a template for each window based on the dimensions entered by the user through user interface 200. Order processing computer 104 may then create a layout of the templates that corresponds to the dimensions of the roll of security film used by film preparation system 106. Order processing computer 104 may also auto-nest or otherwise optimize the arrangement and placement of the templates within the layout to minimize an amount of security film wasted during the cutting process. The templates and layout are then used by film preparation system 106 to cut out a window cutout corresponding to the template for each window as described below with reference to FIGS. 3 and 4.

In one embodiment, order processing computer 104 performs a recursive optimization process when determining the optimal layout for the order. More specifically, for each window template, order processing computer 104 may determine each possible position within the roll of security film to place the window template. For each possible position, order processing computer 104 may then determine each possible position of the next window template, and each possible position of the next window template, and so forth. In other words, if window 1 is determined to have multiple possible positions within the roll, order processing computer 104 determines each possible position of window 2 when window 1 is in a first position, and so forth for each other window template within the order.

Once each window template is laid out in a potential layout, a value is assigned to the potential layout. The value may be, for example, the total area taken up by all window templates within the roll. Alternatively, the value may be the total length of the roll of security film taken up by the potential layout. Once values have been assigned to all potential layouts in the recursive process, order fulfillment may select the potential layout with the lowest value as the optimal layout. Since the lowest value represents the least amount of area taken up by the layout on the roll of security film, the optimal layout thus represents the layout resulting in the least amount of potential wastage of the security film. While order processing computer 104 is described herein as using a recursive optimization process to determine the optimal layout of the window templates (and thus, of the order), it should be recognized that any other suitable process may be used to determine the optimal arrangement of the window templates to minimize the wastage of the security film roll.

In one embodiment, each window template is created with a buffer zone or border that extends past the user-entered dimensions of the window by a predefined amount or percentage. For example, in one embodiment, each window template may have its dimensions extended by 1 inch, or any other amount, on each side of the rectangle formed by the dimensions entered by the user through user interface 200. Alternatively, each window template may have its dimensions extended by 10%, or any other percentage, on each side of the rectangle formed by the user-entered dimensions. In such a manner, each window template may be formed with a buffer zone that enables the installer to customize the placement of the window film on the window during installation, and/or to allow for errors in the measurement of the windows, for example.

Once the order has been validated and the window templates and layout have been created, order processing computer 104 transmits the data representative of the window templates and layout to film preparation system 106 (e.g., to the controller). In response, film preparation system 106 prepares the order for installation by forming window cutouts from the roll of security film corresponding to the window templates and layout as discussed with reference to FIGS. 3 and 4. Film preparation system 106 may also label each window cutout with the label and/or any other fields entered by the user in user interface 200.

FIG. 3 is a side view of an exemplary film preparation system 106. FIG. 4 is a top view of film preparation system 106. In an exemplary embodiment, film preparation system 106 includes a cutting machine 302, a controller 304, and a labeler 306. A roll 308 of security film is also provided on a spindle 310, for example.

In an exemplary embodiment, cutting machine 302 includes a platform 312 on which a portion of roll 308 is placed and fed through machine 302. One or more securing members 314 are provided on platform 312 to engage with a portion or sheet 316 of film unwound from roll 308. Securing members 314 press sheet 316 onto platform 312 and/or feed sheet 316 along platform 312 into and through a cutting area 318 and optionally a labeling area 320. In one embodiment, securing members 314 are rollers 314 that press sheet 316 onto platform 312 and that are controlled by controller 304 to control the speed and duration of the movement of sheet 316 during operation. In an alternative embodiment, securing member 314 may include a movable belt or the like and a vacuum that presses sheet 316 onto platform 312 to enable the movable belt to transport sheet 316 through machine 302. In yet another embodiment, securing member 314 may include a vacuum that presses sheet 316 onto platform 312 to enable sheet 316 to be held in place while being cut. After being cut, the sheet 316 and/or the resulting cutouts may then be disengaged from the vacuum and may be transported through machine 302 by one or more rollers, a movable belt, and/or any other suitable mechanism.

A pair of guide arms 322 are positioned on opposing sides of platform 312 such that sheet 316 passes between guide arms 322 during operation. Guide arms 322 are attached to platform by a plurality of supports 324, in one embodiment. Guide arms 322 enable a movable head 326 to move lengthwise along platform 312 and sheet 316 through the use of a guide motor 328 operated by controller 304.

Movable head 326 is mounted on a transverse arm 330 that moves along guide arms 322 via a plurality of rollers or other securing members (not shown). The movement of transverse arm 330 and the movement of movable head 326 along transverse arm 330 are controlled by controller 304.

A cutting tool 332 is attached to the bottom of movable head 326, facing sheet 316 and platform 312. Cutting tool 332 may be, for example, a blade, a rotating saw, a laser, or any other suitable cutting instrument that is adapted for cutting through sheets 316 of security film. In one embodiment, movable head 326 is controlled by controller 304 to be movable in an upward direction (away from platform 312) and a downward direction (toward platform 312) to enable cutting tool 332 to controllably engage sheet 316 and disengage from sheet 316 during operation as sheet 316 enters cutting area 318. In other words, when controller 304 moves movable head 326 downward into a cutting position, cutting tool 332 cuts the portion of sheet 316 underneath movable head 326. Controller 304 may then control movable head 326 and transverse arm 330 to move head 326 along a pattern corresponding to a window template, thus causing cutting tool 332 to form a window cutout from the roll of security film that matches the window template. Controller 304 may then move cutting tool 332 upward into a non-cutting position to prevent cutting tool 332 from cutting sheet 316 when controller 304 repositions movable head 326, for example.

Controller 304 includes a processor and a memory device for storing data representative of the window templates and/or the layout of the order. Controller 304 controls the operation of cutting machine 302 to cause cutting machine to form a window cutout corresponding to and matching each window template of the order according to the layout received from order processing computer 104.

Labeler 306 includes a printer that prints data onto adhesive labels that may be attached to the window cutouts formed by cutting machine 302. In one embodiment, labeler 306 receives from order processing computer 104 the labels and/or other data that the user entered into the user interface fields for each window through user interface 200. Labeler prints an adhesive label with the user-entered data for each window, and attaches the label to the respective window cutout when the window cutout is moved into labeling area 320 by platform 312 and securing members 314, for example. Labeler 306 may be controlled by controller 304 and is movable along a labeler arm 334 to enable labeler 306 to attach a label to a window cutout in any position within labeling area 320. Labeler 306 may also print a legend on an adhesive label that identifies all window cutouts, their unique identifiers, their intended location for installation, their user-defined description or label, and/or any other suitable data for the order. The legend is printed and included with the window cutouts to enable the installer to quickly and efficiently identify which window cutouts are included in the order and where to install each window cutout.

During operation, controller 304 receives the layout and/or the window templates of the order from order processing computer 104. A sheet 316 of security film is fed into cutting machine 302, and securing members 314 engage sheet 316 to press sheet 316 onto platform 312. Controller 304 operates securing members to move sheet 316 into cutting area 318. Initially, cutting tool 332 is placed in the non-cutting position by moving cutting tool 332 upward, away from platform 312. Controller 304 moves movable head 326 into a starting position corresponding to a first window template of the layout. More specifically, controller 304 moves movable head 326 into the starting position by controlling guide motor 328 and movable head 326 to place head 326 in the starting position. Controller 304 causes movable head 326 to lower cutting tool 332 into the cutting position by moving cutting tool 332 downward into engagement with sheet 316. While cutting tool 332 remains engaged with sheet 316 (thereby cutting through sheet 316), controller 304 moves movable head 326 along a perimeter of the window template to cut out a window cutout matching that window template. When the window cutout has been completed, controller 304 causes cutting tool 332 to be moved into the non-cutting position. Controller 304 then moves movable head 326 into a starting position for the next window template, and the process repeats until cutouts for all window templates have been completed.

When one or more window cutouts have been completed, controller 304 operates securing members 314 to move the cutouts into labeling area 320. Labeler 306 then attaches the corresponding label to each cutout as described above. After each window cutout has been labeled, the order is completed and the labeled cutouts may be automatically or manually placed into one or more shipping containers for transportation to the installation site.

In one embodiment, controller 304 may track a usage of cutting tool 332 and/or of machine 302, such as a number of window cutouts prepared, an amount of time that cutting tool 332 has been engaged in cutting sheets of security film, and/or a cumulative amount of distance traveled by cutting tool 332 when cutting sheets of security film. Controller 304 may store values representative of the usage of cutting tool 332 and/or machine 302 in a memory of controller 304. Controller 304 may also compare the usage values to one or more threshold values stored in the memory. For example, a threshold value may be stored in memory indicating a maximum distance that cutting tool 332 may travel while cutting security film sheets before cutting tool 332 needs to be replaced. As another example, a threshold value may be stored in memory indicating a total amount of time machine 302 may operate before service should be performed on machine 302. Controller 304 may compare the usage value to the threshold value to determine whether the threshold value has been exceeded by the usage value. If controller 304 determines that the usage value exceeds the threshold value, controller 304 may cause a notification to be transmitted or displayed to indicate that service is needed, for example, for the component or machine associated with the usage value and threshold value. The notification may include, for example, activation of a light on movable head 326 or another portion of machine 302 or film preparation system 106, a display of an icon or text on a display associated with controller 304 or film preparation system 106, an email or SMS message transmitted to a computer or device associated with an operator or maintenance personnel of film preparation system 106, and/or any other suitable notification. In one embodiment, when the notification is generated, controller 304 may prevent the use of machine 302 until machine 302 has been serviced.

Exemplary embodiments of a cutting machine, a film preparation system, and an ordering system are described above in detail. The machine and systems are not limited to the specific embodiments described herein, but rather, components of the machine and/or systems may be utilized independently and separately from other components and/or steps described herein. For example, the cutting machine may also be used with other films, and is not limited to practice with only the security film as described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to describe embodiments of the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
an interface provided via a mobile device communicatively coupled to a web server over a network, wherein the mobile device is configured to receive an order input by a user at a first location, the order comprising a plurality of dimensions for a plurality of windows, wherein the dimensions for each window in the plurality of windows include window dimensions comprising a length and a width, and border dimensions comprising an additional length and an additional width automatically generated based on a predefined percentage of the window dimensions; and
an order processing computer communicatively coupled to the web server over the network, wherein the order processing computer is located at a second location and configured to:
receive the order from the mobile device via the web server to prepare a plurality of window cutouts of security film;
generate a plurality of window templates, each template corresponding to a respective one of the plurality of windows;
generate a plurality of potential layouts of the plurality of window templates to be positioned on a portion of security film;
select one of the plurality of potential layouts as the final layout to minimize wastage;
and
a film preparation system in communication with the order processing computer to receive the plurality of window templates and the final layout, the film preparation system comprising:
a roll of security film comprising a laminate security film at least 4 millimeters in thickness suitable for use on a flat window of a building; and
a machine for cutting the security film, the machine comprising:
a platform configured to accept a portion of the roll of security film and transport the portion of the roll into a cutting area;
at least one securing member for securing the portion of the roll of security film to the platform so that the portion of the roll is prevented from moving;
an arm configured to move across the platform in a first direction and an opposing second direction;
a cutting tool movable with the arm and positioned within the cutting area, the cutting tool configured to be placed in a cutting position in which the cutting tool is enabled to cut the security film and a non-cutting position in which the cutting tool is prevented from cutting the security film;
a controller configured to:
receive the plurality of window templates and the final layout; and
move the cutting tool in a predetermined pattern to enable the cutting tool to cut the plurality of window cutouts from the portion of the roll of security film corresponding to the plurality of templates and the final layout; and
a labeler positioned to receive the at least one window cutout as the at least one window cutout is transported from the cutting area, the labeler configured to attach a label to the at least one window cutout.

2. The system of claim 1, wherein the machine further comprises a movable head attached to the arm, wherein the cutting tool is attached to the movable head.

3. The system of claim 2, wherein the controller is configured to control the movable head to raise and lower the cutting tool with respect to the platform.

4. The system of claim 2, wherein the controller is configured to move the movable head along the arm in a third direction and an opposing fourth direction.

5. The system of claim 1, wherein the controller is configured to control the at least one securing member to cause the at least one securing member to transport the portion of the roll along the platform into the cutting area.

6. The system of claim 1, wherein the order processing computer is configured to validate the dimensions before preparing the at least one template.

7. The system of claim 1, wherein the order processing computer is configured to automatically arrange the at least one template within the layout.

8. The system of claim 7, wherein the order processing computer is configured to transmit the at least one template to the controller to enable the controller to control the cutting tool to create the at least one window cutout corresponding to the template.

9. A method comprising the steps of:
providing an interface via a mobile device communicatively coupled to a web server over a network, wherein the mobile device is configured to receive an order input by a user at a first location, the order comprising a plurality of dimensions for a plurality of windows, wherein the dimensions for each window in the plurality of windows include window dimensions comprising a length and a width, and border dimensions comprising an additional length and an additional width automatically generated based on a predefined percentage of the window dimensions;
receiving, by an order processing computer communicatively coupled to the web server over the network, the order from the client device via the web server to prepare a plurality of window cutouts of security film;
generating, by the order processing computer, a plurality of window templates corresponding to a respective one of the plurality of windows;
generating, by the order processing computer, a plurality of potential layouts of the plurality of window templates to be positioned on a portion of security film;
selecting one of the plurality of potential layouts as the final layout to minimize wastage;
receiving, by a film preparation system in communication with the order processing computer, the plurality window templates and the final layout; and
causing, by the film preparation system, a cutting machine to cut a laminate security film that is at least 4 millimeters in thickness suitable for use on a flat window of a building based on the at least one window template and the layout.

10. The method of claim 9, further comprising:
validating, by the order processing computer, the dimensions before preparing the at least one template.

11. The method of claim 9, further comprising:
automatically arranging, by the order processing computer, the at least one template within the layout to minimize waste of the laminate security film.

12. The method of claim 11, further comprising:
transmitting, by the order processing computer, the at least one template to a controller of the cutting machine to enable the controller to control a cutting tool to create the at least one window cutout corresponding to the template.

13. The system of claim 1, wherein the order processing computer, in generating a plurality of potential layouts, is configured to utilize a recursive optimization process.

14. The system of claim 13, wherein the order processing computer, in performing the recursive option process is configured to determine each possible position within the roll of security film to place each window template.

15. The system of claim 13, wherein the order processing computer, in performing the recursive optimization process, is configured to assign a value to each potential layout, wherein the final layout is selected as a function of the values assigned to each potential layout.

16. The system of claim 15, wherein the value is the total taken up by the window templates in the respective layout.

17. The method of claim 9, wherein the step generating a plurality of potential layouts utilizes a recursive optimization process.

18. The method of claim 17, wherein the recursive option process includes the step of: determining each possible position within the roll of security film to place each window template.

19. The method of claim 17, wherein the recursive optimization process includes the step of assigning a value to each potential layout, wherein the final layout is selected as a function of the values assigned to each potential layout.

20. The method of claim 19, wherein the value is the total taken up by the window templates in the respective layout.
